(19) United States
(12) Patent Application Publication
(10) Pub. No.: US 2026/0298013 A1
(43) Pub. Date: Oct. 1, 2026

(54) AUTOMATIC SWITCH DEVICE

(71) Applicant: Chunfeng ZHANG, Shenzhen (CN)

(72) Inventor: Chunfeng ZHANG, Shenzhen (CN)

(21) Appl. No.: 19/237,849

(22) Filed: Jun. 13, 2025

(30) Foreign Application Priority Data
Mar. 28, 2025 (CN) 202520569543.9

(51) Int. Cl. E05F 15/70; A01K 1/00; E05D 15/06; E05F 15/635; E05F 15/643

(52) U.S. Cl. CPC E05F 15/70; E05D 15/0647; E05F 15/635; E05F 15/643; E05Y 2400/354; E05Y 2400/612; E05Y 2600/45; E05Y 2900/132

(57) ABSTRACT

An automatic switch device includes a door frame, at least one door plate, a transmission component, a drive component, an in-position detector or a cut-off switch, and a main control board. The transmission component and the drive component are mounted on the door frame. The drive component is configured to drive the transmission component, and the transmission component is configured to drive the at least one door plate to move translationally relative to the door frame in a first direction to open or close the passageway opening. The in-position detector or the cut-off switch is provided on the door frame and configured to generate a sensing signal or cut off a power supply circuit when the at least one door plate is moved to a closed position. The main control board is configured to stop the drive component working according to the sensing signal or a power cut-off signal.

### CROSS-REFERENCE TO RELATED APPLICATION

The present disclosure claims priority to and the benefit of Chinese Application Patent Serial No. 202520569543.9, filed with the Chinese Patent Office on Mar. 28, 2025. The disclosures of the aforementioned disclosures are hereby incorporated by reference in their entireties.

### TECHNICAL FIELD

The present disclosure relates to the technical field of animal breeding facilities, and in particular to an automatic switch device.

### BACKGROUND

In breeding management processes of animals, opening control operation and closing control operation of breeding doors are important and frequent operations. At present, there are many shortcomings in switching devices of the breeding doors on the market.

Most of the breeding doors are configured as manual sliding doors. These breeding doors need manual operation to realize the opening and closing operations, which is extremely inconvenient in the process of using. Breeders need to personally go to locations adjacent to the breeding doors to perform push action and pull action, and due to the busyness of daily affairs, it is easy to forget to open and close the breeding doors. For example, when the breeders forget to open the breeding doors, animals may not have access to food, water, or space to move in a timely manner. In addition, when the breeders forget to close the breeding doors, animals may escape, thus resulting in economic loss or other safety hazards.

Most of the existing automatic switch devices use drive components to push linkage assemblies to realize the rotation of the breeding doors relative to the breeding bodies in order to open and close passageway openings for the animals to enter and exit, which results in the automatic switch device occupies a large space, and the linkage assembly contains a large number of moving parts, which results in the structure of the automatic switch device being complex, thus increasing the difficulty in the installation, increases the requirement for installation space, and making it difficult to install and use in some breeding houses with limited space or special layouts.

### SUMMARY

In view of the above, one of the purposes of the present disclosure is to provide an automatic switch device to solve the existing technology of the automatic switch device occupies a large space, and the linkage assembly of the automatic switch device contains a large number of moving parts, which results in the structure of the automatic switch device being complex, thus increasing the difficulty in the installation, increases the requirement for installation space, and making it difficult to install and use in some breeding houses with limited space or special layouts.

Embodiments of the present disclosure provide an automatic switch device, which is applied to a breeding house. The automatic switch device includes a door frame, at least one door plate, a transmission component, a drive component, an in-position detector or a cut-off switch, and a main control board. The door frame is configured to be mounted on an edge of a passageway opening of the breeding house. The at least one door plate is movably mounted on the door frame. The transmission component is mounted on the door frame and is force-transmittingly coupled to the at least one door plate. The drive component is mounted on the door frame and is force-transmittingly coupled to the transmission component. The drive component is configured to drive the transmission component, and the transmission component is configured to drive the at least one door plate to move translationally relative to the door frame in a first direction to open or close the passageway opening. The in-position detector is provided on the door frame and configured to generate a sensing signal when the in-position detector detects that the at least one door plate is moved to a closed position relative to the door frame. The cut-off switch is provided on the door frame and configured to cut off a power supply circuit connected with the drive component when the at least one door plate is moved to a closed position relative to the door frame. The main control board is connected with the in-position detector or the cut-off switch, the main control board is configured to receive the sensing signal detected by the in-position detector or receive a power cut-off signal sent by the cut-off switch, and configured to stop the drive component working according to the sensing signal or the power cut-off signal.

The present disclosure is provided with the automatic switch device, on a first aspect, the drive component is mounted on the door frame and is force-transmittingly coupled to the at least one door plate, the drive component is mounted on the door frame and is force-transmittingly coupled to the transmission component, and the drive component is configured to drive the transmission component to drive the at least one door plate to open or close the passageway opening, such that the automatic switch device is able to realize automatic control of the door plate to open or close the passageway opening, which improves the efficiency and safety of breeding animal management, simplifies the structure of the automatic switch device, reduces the difficulty of installation of each component and the requirements for the installation space, makes the automatic switch device adaptable to more installation scenarios, improves the adjustable flexibility of the state of use, and improves the use experience of the breeders. On a second aspect, the drive component can be configured to drive the transmission component to drive the at least one door plate to move in translation relative to the door frame, such that the automatic switch device does not take up the opening radius of the door plate when opening the passageway opening, which is suitable for places with limited space, and the at least one door plate can be tightly adhered to the door frame when closing the passageway opening, which enables the automatic switch device to have good soundproofing, sealing, and wind-resistant performance, as well as avoids the problem of the uncontrolled falling of the door plate in a vertical direction to smash and injure animals. On a third aspect, the main control board may be configured to stop the drive component working according to the sensing signal detected by the in-position detector or the power cut-off signal sent by the cut-off switch, which reduces the damage of the drive component and avoids the problem of mechanical collision or damage between the door plate and the door frame due to excessive translation of the door plate.

### BRIEF DESCRIPTION OF THE DRAWINGS

In order to describe the technical solutions in the present disclosure or prior art more clearly, the accompanying drawings required to be used in the implementations will be simply introduced below. It is apparent that the accompanying drawings in the following descriptions are only some implementations of the present disclosure or prior art. Those of ordinary skill in the art may further obtain other apparent variations according to these accompanying drawings without creative work.

FIG. 1 is a schematic view of an automatic switch device mounted on a breeding house according to a first embodiment of the present disclosure.

FIG. 2 is a partial schematic view of a back surface of the automatic switch device shown in FIG. 1 in an open state.

FIG. 3 is a partial schematic view of a front surface of the automatic switch device shown in FIG. 1 in an open state.

FIG. 4 is a schematic view of a front surface of the automatic switch device shown in FIG. 1 in an open state.

FIG. 5 is a schematic view of a side surface of the automatic switch device shown in FIG. 1 in an open state.

FIG. 6 is an exploded view of the automatic switch device shown in FIG. 1.

FIG. 7 is a schematic view of the automatic switch device shown in FIG. 1 in which a door plate is in contact with an in-position detector.

FIG. 8 is an enlarged view of portions I shown in FIG. 6.

FIG. 9 is a schematic view of a front surface of the automatic switch device shown in FIG. 1 in a closed state.

FIG. 10 is an enlarged view of portions II shown in FIG. 5.

FIG. 11 is a partial schematic view of a back surface of the automatic switch device according to a second embodiment of the present disclosure in an open state.

FIG. 12 is a partial schematic view of a front surface of the automatic switch device shown in FIG. 11 in the open state.

The following specific embodiments will further illustrate the present disclosure in conjunction with the above accompanying drawings.

### DETAILED DESCRIPTION

The technical solutions in the implementations of the present disclosure are clearly and completely described in the following in conjunction with the accompanying drawings of the present disclosure. It is apparent that the described implementations are only part of the implementations of the present disclosure, not all of the implementations. On the basis of the implementations of the present disclosure, all other implementations obtained on the premise of no creative work of those of ordinary skill in the art shall fall within the scope of protection of the present disclosure.

It should be appreciated that the terms in the specification and the claims of the present disclosure and the above-described accompanying drawings are used only to describe a particular embodiment, and are not intended to limit the present disclosure. The terms “first” and “second” in the specification and claims of the present disclosure and the above-described accompanying drawings are used to distinguish between different objects, and are not used to describe a particular order. The singular forms “one” and “the” are also intended to include the plural form unless the context clearly indicates otherwise. The term “including”, and any variations thereof, is intended to cover non-exclusive inclusion. In addition, the present disclosure can be realized in many different forms and is not limited to the embodiments described herein. The following specific embodiments are provided to facilitate a clearer and more thorough understanding of the disclosure of the present disclosure, wherein the terms indicating orientation such as up, down, left, and right, are directed only to the position of the structure shown in the corresponding accompanying drawings. In the description of the present disclosure, it is to be noted that, unless otherwise expressly provided and limited, the terms “mounted”, “connected”, “connected”, “arranged on . . . ”, and “provided with” are to be understood in a broad sense. For example, the elements may be fixedly connected, detachably connected, or integrally connected. The elements may be mechanically connected. The elements may be directly connected, or indirectly connected through an intermediate medium. For a person of ordinary skill in the art, the specific meaning of the above terms in the present disclosure can be understood in specific cases.

The specification hereinafter describes preferred embodiments for implementing the present disclosure, however, the above description is intended to illustrate the general principles of the present disclosure and is not intended to limit the scope of the present disclosure. The scope of protection of this application shall be as defined in the appended claims. The present disclosure is described in further detail below in connection with the accompanying drawings.

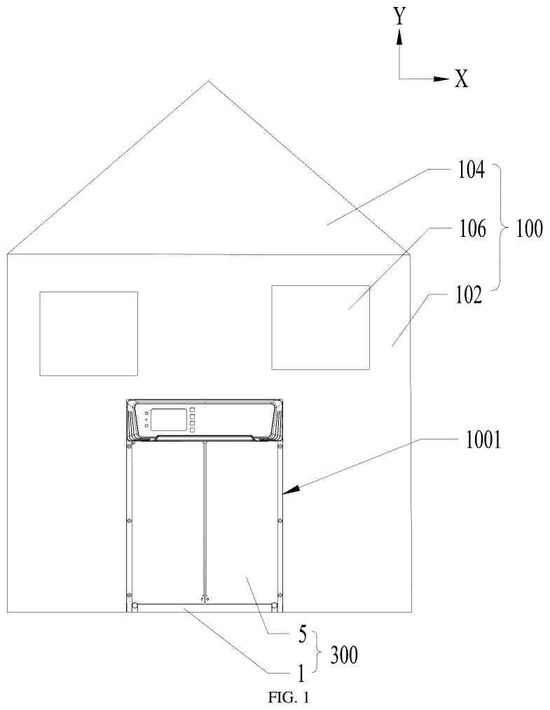

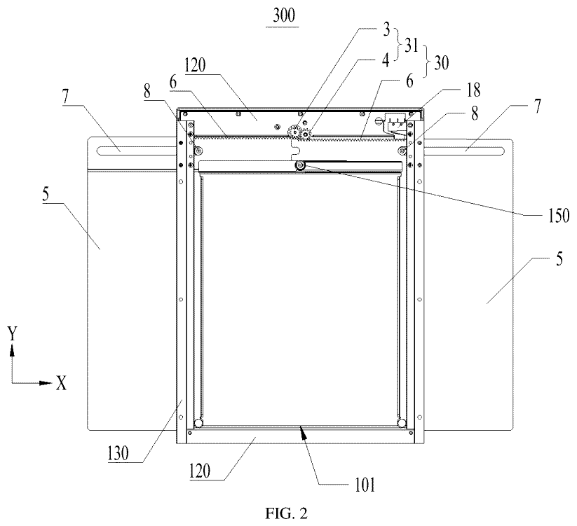

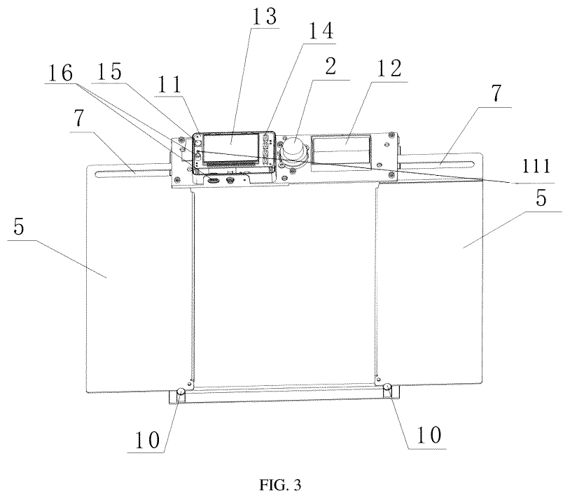

As illustrated in FIG. 1 to FIG. 3, FIG. 1 is a schematic view of an automatic switch device 300 mounted on a breeding house 100 according to a first embodiment of the present disclosure, FIG. 2 is a partial schematic view of a back surface of the automatic switch device 300 of FIG. 1 in an open state, and FIG. 3 is a partial schematic view of a front surface of the automatic switch device 300 of FIG. 1 in an open state. The automatic switch device 300 is applied to a breeding house 100. The automatic switch device 300 includes a door frame 1, at least one door plate 5, a transmission component 30, a drive component 18, an in-position detector 18, and a main control board 11. The door frame 1 is configured to be mounted on an edge of a passageway opening 1001 of the breeding house 100. The at least one door plate 5 is movably mounted on the door frame 1. The transmission component 30 is mounted on the door frame 1 and is force-transmittingly coupled to the at least one door plate 5. The drive component 2 is mounted on the door frame 1 and is force-transmittingly coupled to the transmission component 30. The drive component 2 is configured to drive the transmission component 30, and the transmission component 30 is configured to drive the at least one door plate 5 to move translationally relative to the door frame 1 in a first direction X to open or close the passageway opening 1001. The in-position detector 18 is provided on the door frame 1 and configured to generate a sensing signal when the in-position detector 18 detects that the at least one door plate 5 is moved to a closed position relative to the door frame 1. The main control board 11 is connected with the in-position detector 18. The main control board 11 is configured to receive the sensing signal detected by the in-position detector 18, and configured to stop the drive component 2 working according to the sensing signal.

In some embodiments, the in-position detector 18 may be replaced with a cut-off switch. Specifically, the automatic switch device 300 includes a door frame 1, at least one door plate 5, a transmission component 30, a drive component 18, the cut-off switch, and a main control board 11. The door frame 1 is configured to be mounted on an edge of a passageway opening 1001 of the breeding house 100. The at least one door plate 5 is movably mounted on the door frame 1. The transmission component 30 is mounted on the door frame 1 and is force-transmittingly coupled to the at least one door plate 5. The drive component 2 is mounted on the door frame 1 and is force-transmittingly coupled to the transmission component 30. The drive component 2 is configured to drive the transmission component 30 to drive the at least one door plate 5 to move in translation relative to the door frame 1 to open or close the passageway opening 1001. The cut-off switch is provided on the door frame 1 and configured to cut off a power supply circuit connected with the drive component 2 when the at least one door plate 5 is moved to a closed position relative to the door frame 1. The main control board 11 is connected with the cut-off switch. The main control board 11 is configured to receive a power cut-off signal sent by the cut-off switch, and configured to stop drive component 2 working according to the power cut-off signal.

The present disclosure is provided with the automatic switch device 300, on a first aspect, the drive component 2 is mounted on the door frame 1 and is force-transmittingly coupled to the at least one door plate 5, the drive component 2 is mounted on the door frame 1 and is force-transmittingly coupled to the transmission component 30, and the drive component 2 is configured to drive the transmission component 30 to drive the at least one door plate 5 to open or close the passageway opening 1001, such that the automatic switch device 300 is able to realize automatic control of the door plate 5 to open or close the passageway opening 1001, which improves the efficiency and safety of breeding animal management, simplifies the structure of the automatic switch device 300, reduces the difficulty of installation of each component and the requirements for the installation space, makes the automatic switch device 300 adaptable to more installation scenarios, improves the adjustable flexibility of the state of use, and improves the use experience of the breeders. On a second aspect, the drive component 2 can be configured to drive the transmission component 30 to drive the at least one door plate 5 to move in translation relative to the door frame 1, such that the automatic switch device 300 does not take up the opening radius of the door plate 5 when opening the passageway opening 1001, which is suitable for places with limited space, and the at least one door plate 5 can be tightly adhered to the door frame 1 when closing the passageway opening 1001, which enables the automatic switch device 300 to have good soundproofing, sealing, and wind-resistant performance, as well as avoids the problem of the uncontrolled falling of the door plate 5 in a vertical direction to smash and injure animals. On a third aspect, the main control board 11 may be configured to stop the drive component 2 working according to the sensing signal detected by the in-position detector 18 or the power cut-off signal sent by the cut-off switch, which reduces the damage of the drive component 2 and avoids the problem of mechanical collision or damage between the door plate 5 and the door frame 1 due to excessive translation of the door plate 5.

The breeding house 100 is an enclosed or semi-enclosed apparatus, and is configured to be centralized feeding and management of animals. The breeding house is commonly used in animal husbandry and farming. The animals may be, but are not limited to, chickens, ducks, rabbits, cows, sheep, and the like. The breeding house 100 may be, but is not limited to, a chicken coop, a duck coop, a rabbit coop, a cow coop, a sheep coop, and the like. Understandably, in order to enable the person skilled in the art to better understand the automatic switch device 300, the first embodiment of the present disclosure is illustrated in detail by an example of the automatic switch device 300 being applied to the chicken coop. It is to be noted that the application scenario of the automatic switch device 300 as the chicken coop is only used for illustration purposes, the present disclosure is not specifically limited, and the type of the application scenario of the automatic switch device 300 may be set according to actual needs.

Exemplarily, in the embodiment, the breeding house 100 may include a breeding body 102 and a breeding cover 104. The breeding cover 104 is arranged over the breeding body 102. The breeding body 102 may be, but is not limited to, an enclosure or a fence, etc. At least one of the enclosure body 102 and the breeding cover 104 is provided with a ventilation window 106, thus facilitating the exchange of indoor and outdoor air in the breeding house 100, keeping the air fresh, and enhancing the comfort of the animal's residence. Of course, in some embodiments, the breeding house 100 may omit the breeding cover 104, i.e., the breeding house 100 includes only the breeding body 102.

For accuracy of description, please refer to FIG. 2 whenever orientation is involved herein. The term “first direction X” refers to a direction within a carrying surface for carrying the automatic switch device 300, i.e., left and right directions. In the embodiment, a translational direction of the door plate 5 movable related to the door frame 1 is parallel to the first direction X. The carrying surface is a surface parallel to a ground surface and perpendicular to a direction of gravity of the automatic switch device 300. The term “vertical direction Y” means a direction perpendicular to the carrying surface of the automatic switch device 300, i.e., up and down direction. the first direction X and the vertical direction Y together constitute two orthogonal directions of the automatic switch device 300. For the convenience of description, the first direction X and the vertical direction Y in present disclosure are relative positions and do not constitute a limitation to realize the limitation. The first direction X and the vertical direction Y may be customized according to the specific structure of the product and the perspective presented in the accompanying drawings, and the present disclosure is not specifically limited.

Exemplarily, in the embodiment, the drive component 2 is configured to drive the transmission member 30 to drive the at least one door plate 5 to move in a translational motion in the first direction X relative to the door frame 1, thereby avoiding a problem that the at least one door plate 5 is fall under gravity when the automatic switch device 300 is in an uncontrolled state, preventing the falling door plate 5 from injuring animals or keepers, and thereby improving the safety of the use of the automatic switch device 300. In other words, the translational direction of the door plate 5 is parallel to the first direction X. Of course, in some embodiments, the drive component 2 is configured to drive the transmission member 30 to drive the at least one door plate 5 to move translationally in the vertical direction Y relative to the door frame 1. In other words, the translational direction of the door plate 5 is parallel to the vertical direction Y.

It is to be noted that FIG. 2 is intended only to schematically depict the arrangement between the door frame 1, the door plate 5, the transmission member 30, the drive component 2, and the main control board 11, and is not intended to make specific limitations on the connection positions, connection relationships and specific constructions of the individual components. FIG. 2 is only a structure of the automatic switch device 300 schematically illustrated by an embodiment of the present disclosure, and does not constitute a specific limitation of the automatic switch device 300. In other embodiments of the present disclosure, the automatic switch device 300 may include more or fewer components than those shown in FIG. 2, or a combination of certain components, or different components. For example, the automatic switch device 300 may also include, but is not limited to, a communication module, a protection module, and the like. The communication module is capable of receiving commands from a mobile device. The mobile device may be, but is not limited to, a cell phone, a computer, a remote control, and the like. The command may be an open door command or a close door command. The protection module is mounted on the door plate 5. The protection module may be, but is not limited to, rubber, sponge, etc. thus preventing the door plate 5 from scratching the animals.

Exemplarily, in the embodiment, a vertical distance between each door plate 5 and the ground surface is smaller than a vertical distance between the door frame 1 and the ground surface, thus reducing friction between each door plate 5 and the ground surface, enhancing the smoothness and reliability of the translational movement of each door plate 5 relative to the door frame 1, and thereby reducing contamination of each door plate 5 by animal feces.

The door frame 1 is fixed to the edge of the passageway opening 1001 of the breeding house 100. Exemplarily, in the embodiment, the door frame 1 is detachably connected to the breeding house 100, thus facilitating operations such as assembly, maintenance and replacement of the automatic switch device 300. Of course, in some embodiments, the door frame 1 and the breeding house 100 may also be made in one piece, and the embodiments of the present disclosure are not specifically limited.

The door frame 1 is provided with an entrance 101 in air communication with the passageway opening 1001. Exemplarily, in the embodiment, the door frame 1 includes a first cross beam 110, a second cross beam 120, and two vertical beams 130. the first cross beam 110, the second cross beam 120, and the two vertical beams 130 are coupled to form the entrance 101, thus realizing the animals or breeders entering or exiting the breeding house 100. Specially, upper ends of the two vertical beams 130 are coupled to two ends of the first cross beam 110, respectively, and lower ends of the two vertical beams 130 are coupled to two ends of the second cross beam 120, respectively, thus improving the overall structural strength of the door frame 1, and thereby improving the solidity and reliability of the connection between the door frame 1 and the breeding house 100. Of course, in some embodiments, the second cross beam 120 may be omitted, i.e., the door frame 1 only includes the first cross beam 110 and the two vertical beams 130, and the two vertical beams 130 are coupled to two ends of the first cross beam 110, respectively.

The first cross beam 110 is located above the second cross beam 120, and the drive component 2 and the transmission member 30 are provided on the first cross beam 110. Thereby, on the one hand, a risk of animals or keepers accidentally touching the drive component 2 may be reduced, thus reducing the safety hazard of the automatic switch device 300, reducing the erosion of the electrical components such as the drive component 2 by ground dust, moisture, and feces, etc., and prolonging the service life of the automatic switch device 300; and on the other hand, an occupancy rate of floor space of the automatic switch device 300 may be reduced, thus avoiding a problem of affecting the movement of the animals. Of course, in some embodiments, the drive component 2 and the transmission member 30 may also be provided at the second cross beam 120 or at a location where the door frame 1 is provided between the first cross beam 110 and the second cross beam 120, and the embodiments of the present disclosure are not specifically limited.

Specifically, the drive component 2 and the transmission member 30 are provided in a middle of the first cross beam 110, thereby improving the force uniformity of the first cross beam 110, shortening a movement distance of the door plate 5 relative to the door frame 1, and improving the compactness of the automatic switch device 300. The door frame 1 is configured as a support structure for supporting the drive component 2 and the transmission member 30. Material of the door frame 1 may include, but is not limited to, at least one of steel, wood, alloy, and the like. Exemplarily, in the embodiment, the material of the door frame 1 is made of steel, thus making the door frame 1 strong, durable, fire-resistant, and other advantages, and facilitating maintenance and cleaning.

In the first embodiment, the transmission member 30 is configured as a gear transmission member. The transmission component 30 includes a driven gear 31 and a rack 6. The driven gear 31 is force-transmittingly coupled to the drive component 2. The rack 6 is meshed with the driven gear 31 and is fixedly coupled to the at least one door plate 5. Meshing transmission between the driven gear 31 and the rack 6 drives the at least one door plate 5 to open or close the passageway opening 1001, on a first aspect, the meshing transmission between the driven gear 31 and the rack 6 is able to reduce vibration and impact, which improves the smoothness and accuracy of the movement of the at least one door plate 5 relative to the door frame 1, and improves the service life of the automatic switch device 300. One a second aspect, the structure of the driven gear 31 and the rack 6 is simple, which is easy to maintain and is able to withstand large loads. On a third aspect, the transmission efficiency of the driven gear 31 and the rack 6 is high, which reduces energy loss and lowering operating costs, and the driven gear 31 and the rack 6 can be designed to realize a self-locking function, which prevents accidental movement of the at least one door plate 5 relative to the door frame 1, and improves the safety of the use of the automatic switch device 300.

Exemplarily, in the embodiment, the rack 6 and the door plate 5 is made in one piece, thus enhancing the strength and stability of the connection between the rack 6 and the door plate 5, reducing a risk of malfunction due to loosening of the connection, and enhancing the overall performance and service life of the door plate 5. Of course, in some embodiments, the rack 6 and the door plate 5 are arranged independently of each other, and the rack 6 is fixedly coupled to the door plate 5, thus reducing the processing difficulty of the rack 6 and the door plate 5, and facilitating maintenance. The door plate 5 is made of a high-strength and smooth-surface material, thus preventing scratching by animals such as cattle and sheep.

The door plate 5 is provided as two in number. The two door plates 5 are coupled to the door frame 1. The two door plates 5 form a side-by-side door. The rack 6 is provided as two in number. In a first aspect, the simultaneous opening of the two door plates 5 can provide a wider passageway opening 1001, which facilitates rapid evacuation of chickens or people, and in a second aspect, a distance that each door plate 5 moves relative to the door frame 1 is shortened, which improves the compactness of the overall structure of the automatic switch device 300.

The two door plates 5 are staggered in an in-out direction of the passageway opening 1001. The drive component 2 is configured to drive the transmission member 30 to drive the two door plates 5 to move translationally relative to the door frame 1 in opposite directions. That is, the transmission member 30 is configured to drive the two door plates 5 to move translationally relative to the door frame 1 in opposite directions. On the one hand, the same drive component 2 is configured to drive the transmission component 30 to drive the two door plates 5 to move at the same time, which saves costs, reduces the number of components, facilitates assembly, and reduces the difficulty of maintenance of the automatic switch device 300, and on the other hand, the two door plates 5 are staggered in the in-out direction of the passageway opening 1001, which avoids a problem of collision, scratch, and abrasion when the two door plates 5 move relative to the door frame 1, and improves the smoothness and reliability of the two door panels 5 in translation movement.

In some embodiments, when the two door plates 5 close the passageway opening 1001, a projection of the two door plates 5 in a second direction is located within a projection of the door frame 1 in the second direction. The second direction is parallel to an in-out direction of the passageway opening 1001 and perpendicular to the first direction X. When the two door plates 5 close the passageway opening 1001, a problem of the door plate 5 protruding relative to the door frame 1 and being broken by the feeder and causing the feeder to be injured by the cut of the door plate 5 may be avoided.

The driven gear 31 includes a main drive gear 3 and a driven gear 4. The main drive gear 3 is force-transmittingly coupled to the drive component 2. The driven gear 4 is meshed with the main drive gear 3. One of the two door plates 5 is meshed with the main drive gear 3 by an associated rack 6, and an another door plate 5 is engaged with the driven gear 4 by an another associated rack 6. The main drive gear 3 and the driven gear 4 are provided as one in number, thus improving the synchronization of the movement of the two door plates 5 relative to the door frame 1, reducing the number of elements of the drive gear 31, saving costs, and improving the compactness of the structure. The two door plates 5 are arranged symmetrically relative to the door frame 1, thus improving the aesthetics of the vision of the automatic switch device 300, which is suitable for a modern chicken coop. Of course, in some embodiments, the two door plates 5 are provided asymmetrically relative to the door frame 1.

In some embodiments, the driven gear 31 includes a main drive gear 3 and two driven gears 4. The main drive gear 3 is force-transmittingly coupled to the drive component 2. The two driven gears 4 are both meshed with the main drive gear 3. each of the two door plates 5 is engaged with the main drive gear 3 by an associated driven gear 6, thus facilitating installation and commissioning, and saving time and labor.

In other embodiments, the driven gear 31 includes two main drive gears 3. The drive component 2 is provided as two in number. The two main drive gears 3 are force-transmittingly coupled to the two drive components 2, respectively. Each of the two door plates 5 is engaged with an associated main drive gear 3 by an associated rack 6. On the one hand, one or both of the two door plates 5 can be controlled to move relative to the door frame 1 as needed, which improves the flexibility of use, and on the other hand, when one of the drive components 2 fails, the other drive component 2 can still work, which is convenient for maintenance and overhauling, and the two drive components 2 share loads together, which is more stable in operation and reduces vibration and noise.

Of course, in some other embodiments, the door plate 5 can be provided as one in number. The driven gear 31 can only include the master driving gear 3. The number of the master driving gear 3 and the slave driving gear 4 can be set according to the actual situation, and this embodiment is not specifically limited.

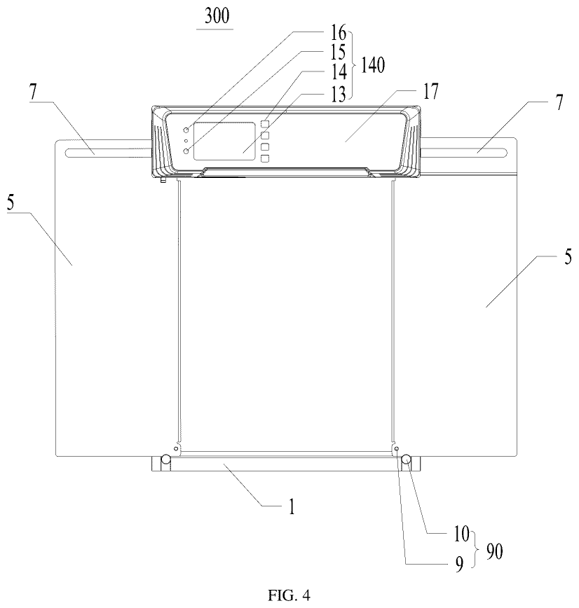

As illustrated in FIG. 3 and FIG. 4, FIG. 4 is a schematic view of a front surface of the automatic switch device 300 shown in FIG. 1 in an open state. In some embodiments, the automatic switch device 300 further includes a protective housing 17. The protective housing 17 is mounted on the door frame 1 and covered on an outside of the main control board 11, the drive component 2 and the transmission component 30. The arrangement of the protective housing 17 protects the main control board 11, the driving part 2 and the transmission part 30, and avoids outside dust, moisture and feces and other debris from entering the inner cavity of the protective housing 17, which causes erosion of the main control board 11, the driving part 2 and other electrical components, and debris that obstructs the transmission part 30 and the transmission movement of the door plate 5, and thereby extending the service life of the automatic switch device 300, and improving the reliability and stability of the operation of the automatic switch device 300.

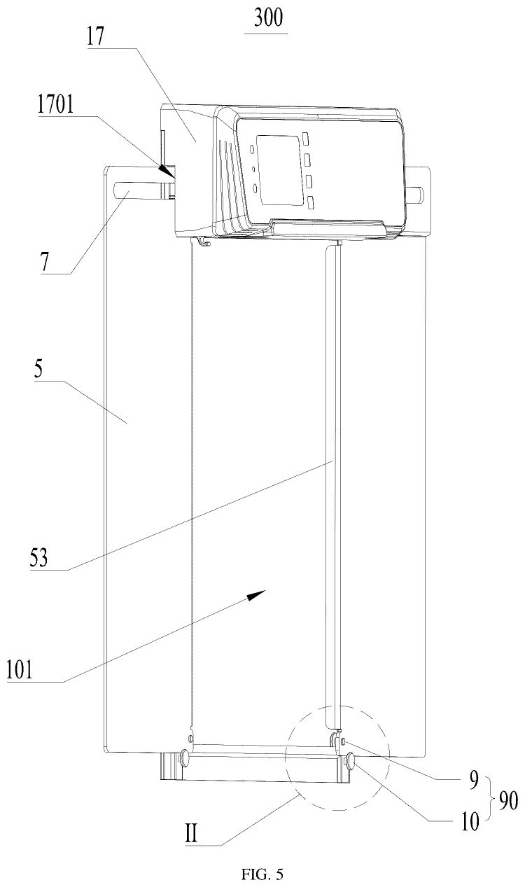

As illustrated in FIG. 4 and FIG. 5, FIG. 5 is a schematic view of a side surface of the automatic switch device 300 shown in FIG. 1 in an open state. Specifically, at least one sidewall of the protective housing 17 in the first direction X is provided with a movable port 1701. In the in-out direction of the passageway opening 1001, the movable port 1701 is provided on a side of the protective housing 17 close to the door frame 1. The door plate 5 is movably passed through the movable port 1701, thus realizing the translational movement of the door plate 5 relative to the door frame 1. In some embodiments, the door plate 5 is slidably passed through the movable port 1701. For example, the door plate 5 is slidably provided against the protective housing 17. On the one hand, the movable opening 1701 can play a guiding role for the translational movement of the door plate 5, and on the other hand, when the door plate 5 closes the passageway opening 1001, the door plate 5 can seal the movable opening 1701, thus avoiding outside dust, moisture and feces and other debris enter into the inner cavity of the protective housing 17, thereby avoiding erosion of the main control board 11, the drive component 2 and other electrical components and debris to impede the transmission components 30 and the transmission movement of the door plate 5, extending the service life of the automatic switch device 300, and improving the reliability and stability of the operation of the automatic switch device 300. Of course, in some embodiments, the door plate 5 and the protective housing 17 are spaced apart at the movable port 1701, thus reducing the friction between the door plate 5 and the protective housing 17 and reducing noise. The number of movable ports 1701 is provided in one-to-one correspondence with the number of door plates 5. Exemplarily, in the embodiment, the movable ports 1701 are also provided as two in number. In other words, each side wall of the protective housing 17 in the first direction X is provided with the movable ports 1701 on a side near the door frame 1.

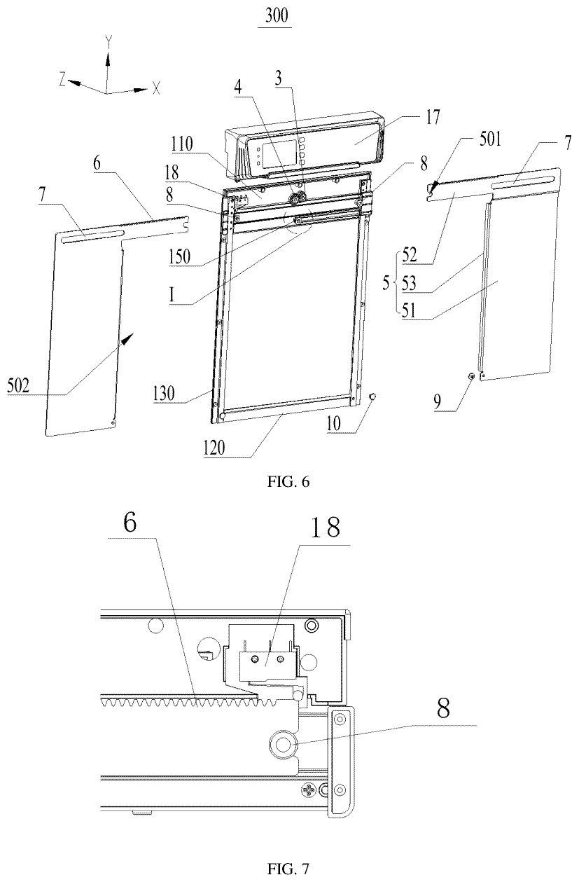

As illustrated in FIG. 6 and FIG. 7, FIG. 6 is an exploded view of the automatic switch device 300 shown in FIG. 1, and FIG. 7 is a schematic view of the automatic switch device 300 shown in FIG. 1 in which a door plate 5 is in contact with an in-position detector 18. Exemplarily, in the embodiment, the in-position detector 18 is provided on the first cross beam 110 of the door frame 1. The in-position detector 18 is configured to generate the sensing signal when the door plate 5 moves to the closing position relative to the door frame 1. Specifically, the in-position detector 18 is provided at least one end of the first cross beam 110 in the first direction X. When the two door plates 5 are moved to the closing position relative to the door frame 1, at least one of the two door plates 5 moved to the closing position press against the in-position detector 18, and the in-position detector 18 is capable of generating the sensing signal and sending the sensing signal to the main control board 11. For example, the in-position detector 18 is provided as one in number. The in-position detector 18 is provided at an end of the first beam 110 in the first direction X. When the two door plates 5 moves at the close position that the two door plates 5 closes the passageway opening 1001, one of the two door plate 5 presses against and triggers the in-position detector 18 to generate the inductive signal, and the main control board 11 controls the drive component 2 to stop working according to the inductive signal. The closing position means that the door plate 5 reaches a position where the two door plates 5 close the passage opening 1001 relative to the door frame 1. When the two door plates 5 move to the closing position relative to the door frame 1, it is indicated that the two door plates 5 close the passageway opening 1001, thereby improving the accuracy and reliability of the translational movement of the two door plates 5 relative to the door frame 1, avoiding the problem of the two door plates 5 moving too large a distance relative to the door frame 1 and causing damage, and improving the safety of the use of the automatic switch device. The in-position detector 18 may be, but is not limited to, a mechanical electronic switch, a photoelectric encoder, a magnetic encoder, a laser ranging sensor, an ultrasonic sensor, and the like. The in-position detector 18 is provided as one in number, and is provided at one of the ends of the first beam 110 in the first direction X. In other embodiments, the in-position detector 18 may also be provided as two in number, and are provided at two ends of the first beam 110 in the first direction X. When each of the door plates 5 move to the closing position, each of the door plates 5 contacts an associated in-place detector 18, thereby increasing the reliability of the two door plates 5 closing the passageway opening 1001. Of course, in some embodiments, the in-position detector 18 is provided at an intermediate position of the first cross beam 110 in the first direction X, and the embodiments of the present disclosure are not specifically limited.

It is noted that, an arrangement position of the cut-off switch provided on the first cross beam 110 may be the same or different from an arrangement position of the in-position detector 18. For example, the cut-off switch may also be provided at one end of the first cross beam 110 in the first direction X. When the at least one door plate 5 is moved to the closing position relative to the door frame 1, the door plate 5 moved to the closing position presses against the cut-off switch so as to cause the cut-off switch to disconnect the power supply circuit between the drive component 2 and the power supply, and the main control board 11 is configured to receive the power supply cut-off signal sent by the cut-off switch and stop the drive component 2 working according to the power supply cut-off signal. As a result, the drive component 2 cannot operate because the power supply circuit between the drive component 2 and the power source is cut off. When the user triggers the automatic switch device 300 to open the passageway opening 1001 again, the cut-off switch connects the power supply circuit between the drive component 2 and the power supply, thereby enabling the drive component 2 to drive the transmission member 30 to drive the at least one door plate 5 to perform a translational movement relative to the door frame 1 to open the passageway opening 1001.

Exemplarily, in the embodiment, the in-position detector 18 is configured as a mechanical electronic switch. The mechanical electronic switch operates by opening and closing a switch contact by mechanical force or magnetic force to break or close a circuit. The mechanical electronic switch utilizes a micro switch. It should be noted that the micro switch is a switch having a tiny contact spacing and a snap-action mechanism, a contact mechanism that carries out the switching action with a prescribed stroke and a prescribed force, a switch that is covered with a housing and has a drive lever on the outside thereof, and a switch that is known as a micro switch because of the relatively small spacing of its switching contacts, also known as a sensitive switch.

Referring again to FIG. 3 to FIG. 6, in some embodiments, the automatic switch device 300 further includes a current detection module 111. The current detection module 111 is electrically connected with the main control board 11. The current detection module 111 is configured to monitor current data of the drive component 2 and to transmit the current data to the main control board 11. When the current data exceeds a preset current range, the main control board 11 is configured to stop the drive component 2 rotating in a forward rotation direction, and rotate the drive component 2 a preset stroke in a direction opposite to the forward rotation direction after the drive component 2 stops. The arrangement of the current detection module 111 is able to provide an anti-pinch function for the automatic switch device 300, reducing the risk of the animal being pinched, and providing a reliable safety guarantee for the breeding animal. Specifically, in a closing process, once the at least one door plate 5 clips the animals, current of the drive component 2 detected by the current detection module 111 is abnormally increased. The current detection module 111 accurately transmits an abnormal current signal to the main control board 11, and the main control board 11 then controls the drive component 2 to stop operation and reverse the preset stroke according to the abnormal current signal, thereby creating an opportunity for the animal to disengage.

It is to be noted that the preset stroke may be a distance at which the at least one door plate 5 is moved relative to the door frame 1 to fully open the passageway opening 1001; alternatively, the preset stroke may be a distance at which the at least one door plate 5 is moved relative to the door frame 1 to partially open the passageway opening 1001. After the main control board 11 controls the drive component 2 to rotate in the direction opposite to the positive rotation direction for a preset time, when the current data of the drive component 2 monitored by the current detection module 111 is in the preset current range, the main control board 11 is configured to rotate the drive component 2 in the positive rotation direction until the at least one door plate 5 is moved to the closing position. The automatic switch device 300 is capable of realizing automatic completion of the closing action, which improves the use experience. Of course, in some embodiments, after the main control board 11 controls the drive component 2 to rotate in the direction opposite to the positive rotation direction for a preset time, the drive component 2 stops working, and when the main control board 11 receives a door closing command from the keeper, the main control board 11 continues to rotate the drive component 2 in the positive direction until the at least one door plate 5 moves to the closing position.

Referring again to FIG. 3 and FIG. 6, in some embodiments, the automatic switch device 300 further includes at least one slide structure 8. Each of the at least one slide structure 8 is provided on the door frame 1. The at least one door plate 5 is provided with a slide groove 7 arranged in one-to-one correspondence with each slide structure 8. An extension direction of each slide groove 7 is parallel to the first direction X. Each slide structure 8 is slidably provided in an associated slide groove 7. In the embodiment, the two door plates 5 are provided the two slide grooves 7, respectively. The automatic switch device 300 includes two slide structures 8 provided on the door frame 1. One of the two door plates 5 is slidably coupled to one of the two slide structures 8, an another one of the two door plates 5 is slidably coupled to an another slide structure 8. A mating connection between the slide groove opening 7 and the slide structure 8 is capable of restricting the movement of the at least one door plate 5 relative to the door frame 1 in the vertical direction Y, thereby improving the accuracy and reliability of the translational movement of the at least one door plate 5 relative to the door frame 1 in the first direction X. Specifically, a top portion of each door plate 5 is provided with the slide groove 7, and the slide structure 8 is mounted on the door frame 1 at a position corresponding to the slide groove 7. The slide groove 7 cooperates with the slide structure 8 to restrict the door plate 5 from being displaced relative to the door frame 1 in the vertical direction Y.

The slide structure 8 is rotationally provided relative to the door frame 1. In the embodiment, the slide structure 8 is configured as a bearing, thus reducing friction and vibration between the door plate 5 and the door frame 1, reducing noise generated during operation of the automatic switch device 300, and improving the stability and reliability of the translational movement of the door plate 5 relative to the door frame 1 along the first direction X. Of course, the slide structure 8 may also be configured as a roller.

Of course, in some embodiments, the slide structure 8 is fixedly provided relative to the door frame 1. The slide structure 8 may be configured as, but is not limited to, a cylindrical structure, semi-cylindrical structure, a prismatic structure, or other shapes of structure.

In some embodiments, the door frame 1 is provided with a carrying structure 150. Each door plate 5 includes a door plate body 51 and an extension plate 52. In the same door plate 5, the extension plate 52 is coupled to a side portion of the door plate body 51 in the first direction X. The extension plate 52 of each door plate 5 is provided between the transmission member 30 and the carrying structure 150. The door plate body 51 is provided with the slide groove 7. The carrying structure 150 is capable of supporting the at least one door plate 5, thus improving the stability and reliability of movement of the at least one door plate 5 relative to the door frame 1.

The at least one door plate 5 is configured as an L-shaped structure. In other words, a bottom of the at least one door plate 5 away from the transmission component 30 is provided with an avoidance notch 502. In other words, in the same the door plate 5, the door plate body 51 and the extension plate 52 are coupled to form the avoidance notch 502. When the passageway opening 1001 is closed by the two door plates 5, the avoidance notch 502 provided on one of the two door plates 5 is configured to arrange in avoidance with the door plate body 51 of an another one of the two door plates 5 therein, thus enhancing the occupancy space of the two door plates 5 on the door frame 1, and improving compactness of the overall structure of the automatic switch device 300. When the two door plates 5 close the passageway opening 1001, the door plate bodies 51 of the two door plates 5 are arranged in rows along the first direction X and abut against each other, and the extension plate 52 of one of the two door plates 5 is located above the door plate body 51 of an another one of the two door plates 5.

In the embodiment, the carrying structure 150 is rotatably provided relative to the door frame 1. The carrying structure 150 is configured as a rotating structure, thus reducing the energy consumption of the movement of the at least one door plate 5 relative to the door frame 1, improving the stable operation of the movement of the at least one door plate 5 relative to the door frame 1, reducing the friction between the at least one door plate 5 and the carrying structure 150, and reducing the noise. For example, the carrying structure 150 is configured as a bearing, thereby reducing friction and vibration between the at least one door plate 5 and the door frame 1, reducing noise generated during operation of the automatic switch device 300, and improving the stability and reliability of the translational movement of the at least one door plate 5 relative to the door frame 1 in the first direction X. Of course, the carrying structure 150 may also be configured as a roller. Of course, in some embodiments, the carrying structure 150 is fixedly provided relative to the door frame 1.

In some embodiments, the automatic switch device 300 further includes a first guide strip 160 and a second guide strip 170. Each of the first guide strip 160 and the second guide strip 170 is protruded on a side wall of the door frame 1 facing toward the at least one door plate 5, and the first guide strip 160 and the second guide strip 170 are configured to abut against the two door plates 5, respectively, thus reducing a contact area between the two door plates 5 and the door frame 1, reducing friction and to reduce noise, and improving the reliability and stability of the sliding of the two door plates 5 relative to the door frame 1. Specifically, the first guide strip 160 and the second guide strip 170 are integrally molded with the first cross beam 110, that is, the first guide strip 160, the second guide strip 170 and the first cross beam 110 are make in one piece. In other embodiments, the first guide strip 160 and the second guide strip 170 are removably connected with the first cross beam 110. Each of the first guide strip 160 and the second guide strip 170 is provided with a rounded corner structure. The rounded corner structure of the first guide strip 160 or the second guide strip 170 abuts against an associated door plate 5, thereby reducing the contact area between the two door plates 5 and the door frame 1, reducing friction, and reducing noise.

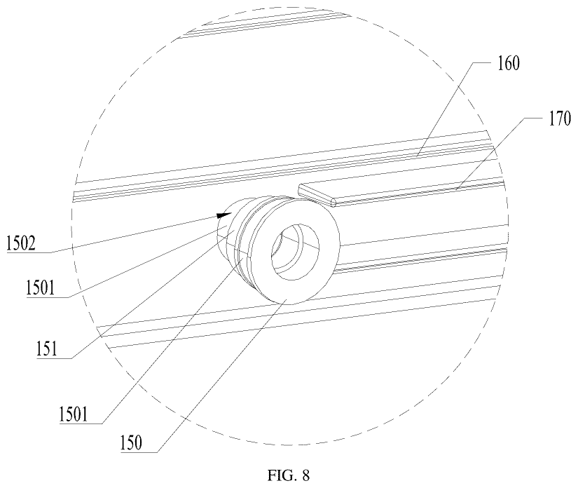

As illustrated in FIG. 6 and FIG. 8, FIG. 8 is an enlarged view of portions I shown in FIG. 6. The carrying structure 150 is provided with a guide slip surface 1502. The guide slip surface 1502 abuts against the extension plate 52. The guide slip surface 1502 is configured as a curved surface, thus reducing friction between the at least one door plate 5 and the carrying structure 150, reduce noise, and improving the smoothness and stability of movement of the at least one door plate 5 relative to the carrying structure 150. Of course, in some embodiments, the slide guide surface 1502 may also be configured as a flat surface.

In the embodiment, the two door plates 5 are arranged along the second direction Z. The automatic switch device 300 has a simple and compact structure, thus occupying little space. Specifically, the carrying structure 150 is provided extending along the second direction Z. A sidewall of the carrying structure 150 is provided with a spacer strip 151, and the two door plates 5 are located on both sides of the spacer strip 151 in the second direction Z. The interference between the two door plates 5 is avoided when the two door plates 5 are moved in translation relative to the door frame 1, thus improving the reliability and smoothness of the movement of the two door plates 5 relative to the door frame 1, and avoiding a problem of wear and noise caused by the two door plates 5 being pressed against each other.

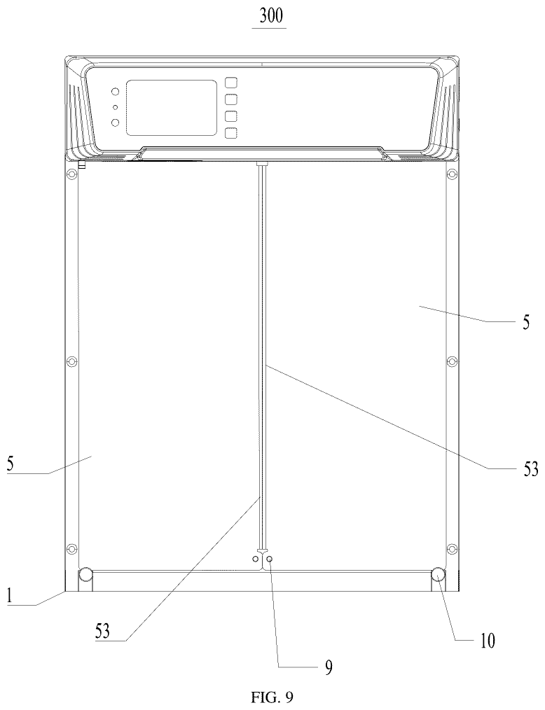

As illustrated in FIG. 6 and FIG. 9, FIG. 9 is a schematic view of a front surface of the automatic switch device 300 shown in FIG. 1 in a closed state. In some embodiments, the carrying structure 150 is provided extending in the second direction Z. A side wall of the carrying structure 150 is provided with two limit grooves 1501. The two limit grooves 1501 are provided spaced apart in the second direction Z, and the two door plates 5 are provided in the two limit grooves 1501, respectively. The interference between the two door plates 5 is avoided when the two door plates 5 are moved in translation relative to the door frame 1, thus improving the reliability and smoothness of the movement of the two door plates 5 relative to the door frame 1, and avoiding a problem of wear and noise caused by the two door plates 5 being pressed against each other.

In some embodiments, each door plate 5 further includes a bending plate 53. In the same the door plate, the bending plate 53 is coupled to a side of the door plate body 51 near the extension plate 52 in the first direction X, and the two bending plates 5 abut against each other when the passageway opening 1001 is closed by the two door plates 5. On the one hand, the overall structural strength of each door plate 5 is improved, and a risk of misalignment and jamming of the two door plates 5 during the closing process is reduced, and on the other hand, the two bent plates 53 are offset against each other, thus avoiding a problem of a gap between the two door bodies that may jam the animals or the keepers.

In some embodiments, in the same the door plate 5, a position notch 501 is provided on the side of the extension plate 52 back to the door plate body 51 in the first direction X. When the passageway opening 1001 is closed by the two door plates 5, each slide structure 8 is positioned in an associated position notch 501. That is, the slide structure 8 slidably coupled to one of the two door palates 5 is positioned in the locating notch 501 provided in another of the two door palates 5 therein. On the one hand, the slide structure 8 can prevent excessive displacement of each door plate 5 relative to the door frame 1, thus improving the accuracy of the translational movement of the door plate 5 and the door frame 1, and preventing damage to the drive component 2, and on the other hand, the slide structure 8 can be used to play a dual positioning role for closing and opening of the door plate 5, thus reducing the number of structural components, improving the rationalization of the arrangement of components, improving the compactness of the overall structure, and facilitating assembly.

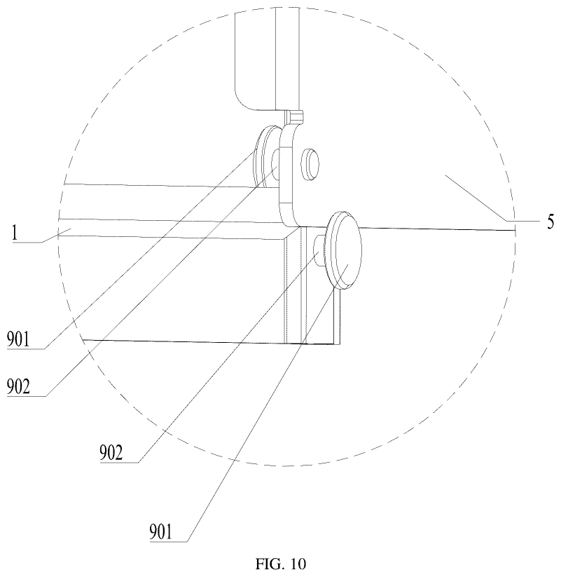

As illustrated in FIG. 4, FIG. 5 and FIG. 10, FIG. 10 is an enlarged view of portions II shown in FIG. 5. In some embodiments, the two door plates 5 are provided stacked with the door frame 1 in the second direction Z. The automatic switch device 300 further includes a limit structure 90. The limit structure 90 is provided on the door frame 1 and/or the at least one door plate 5. The limit structure 90 is configured to limit a movement of the at least one door plate 5 in the second direction Z relative to the door frame 1. On a first aspect, the two door plates 5 are provided stacked with the door frame 1 in the second direction Z, thus solving problems that increasing the difficulty of cleaning the clamping slot due to the clamping slot being contaminated by impurities such as animal feces, and the door panel being hindered in performing translational movement relative to the door frame, which are caused by a clamping slot provided with the existing door frame and configured to limit a movement of the door plate along the thickness direction of the door plate, and thereby reducing the difficulty of cleaning the door frame 1 and the door panel 5, and improving the reliability and smoothness of the translational movement of the door panel 5 relative to the door frame 1. On a second aspect, the limit structure 90 can limit the movement of the door panel 5 relative to the door frame 1 along the thickness direction of the door panel 5, thereby reducing a problem of the door panel 5 bending or even breaking relative to the door frame 1 under an impact force exerted by an animal, thus improving the stability and reliability of the translational movement of the door panel 5 relative to the door frame 1 along the first direction X.

The limit structure 90 includes a limit head 901 and a limit rod 902. One end of the limit rod 902 is coupled to the limit head 901, and an another end of the limit rod 902 is coupled to the door frame 1 or the door plate 5. The limit head 901 is configured to stop with the door frame 1 or the door plate 5 to limit a movement of the door plate 5 in the second direction Z relative to the door frame 1. In the embodiment, the door plate 5 is spaced apart from and located above the limit rod 902 of the limit structure 90. On one hand, the friction between the door plate 5 and the limit structure 90 is reduced, thus improving the smoothness and reliability of the translational movement of the door plate 5 relative to the door frame 1, and on the other hand, when the automatic switch device 300 is out of control and causes the door plate 5 to fall under gravity, a problem of the door plate 5 smashing into the animals or the keepers is avoided, thus improving the safety of the use of the automatic switch device 300. Of course, in some embodiments, the door plate 5 abuts against the limit rod 902 of the limit structure 90, so that the limit structure 90 is able to play a supportive role for the door plate 5, which improves the smoothness and reliability of the translational movement of the door plate 5 relative to the door frame 1.

Exemplarily, in the embodiment, the limit structure 90 is provided as a plurality in number. The plurality limit structures 90 includes a first limit body 9 and a second limit body 10. The first limit body 9 and the second limit body 10 are arranged on different sides of the door frame 1 in the second direction Z. The first limit body 9 is mounted on the door plate 5 and stops with the door frame 1 in the second direction Z. The second limit body 10 is mounted on the door frame 1 and stops with the door plate 5 in the second direction Z. The at least one door plate 5 is provided between the first limit body 9 and the second limit body 10. Specifically, each the first limit body 9 and the second limit body 10 includes the limit head 901 and the limit rod 902. The limit head 901 of the first limit body 9 is stopped with the door frame 1 in the direction of the thickness of the door plate 5. The limit head 901 of the second limit body 10 is stopped with the door plate 5 in the direction of the thickness of the door plate 5. Such that the synergistic action of the first limit body 9 and the second limit body 10 can prevent the door plate 5 from swaying back and forth due to the pushing and squeezing of the animal, which improves the stability and accuracy of the door plate 5 in the opening process and the closing process, and enhances the overall reliability and service life of the automatic switch device 300.

The first limit body 9 and the second limit body 10 are provided in a plurality. The plurality of first limit bodies 9 are arranged in one-to-one correspondence with the plurality of second limit bodies 10. The plurality of first limit bodies 9 and the plurality of second limit bodies 10 form a plurality of limit assemblies. One of the two door panels 5 is provided between the first limit body 9 and the second limit body 10 of one of the limit assemblies, and an another one of the two door panels 5 provided between the first limit body 9 and the second limit body 10 of an another one of the limit assemblies. The first limit body 9 is arranged at a bottom of the door plate 5, and the second limit body 10 is arranged at the second cross beam 120 of the door frame 1.

Exemplarily, in the embodiment, the first limit body 9 and the door plate 5 are provided independently of each other and fixedly connected. The second limit body 10 and the door frame 1 are also provided independently of each other and fixedly connected. For example, each of the first limit body 9 and the second limit body 10 are configured as a rivet structure. Of course, in some embodiments, the first limit body 9 is integrally molded with the door plate 5, that is, the first limit body 9 and the door plate 5 are made in one piece. The second limit body 10 is integrally molded with the door frame 1 that is, the second limit body 10 and the door frame 1 are made in one piece. The first limit body 9 and the second limit body 10 may both be provided on the door frame 1 or the door plate 5, and the embodiments of this application are not specifically limited.

In some embodiments, the automatic switch device 300 further includes an energy storage member 12. The energy storage member 12 is electrically connected with the main control board 11 and the drive component 2. The protective housing 17 is provided on an outside of the energy storage member 12. The energy storage member 12 is capable of supplying power to the drive component 2, the main control board, and other electrical components, thus simplifying the connection lines of the automatic switch device 300, omitting external connection cables, and having a simple and beautiful structure. The energy storage member 12 may include a battery or a capacitor. The energy storage member 12 may be configured as a rechargeable structure or a non-rechargeable structure, which is not specifically limited by this application.

In some embodiments, the automatic switch device 300 further includes a function member 140. The function member 140 is provided on the main control board 11. The function member 140 includes, but is not limited to, at least one of a display 13, a button 14, a prompt structure 15, and a connection interface 16. Such that a multifunctional experience of realizing the automatic switch device 300 is achieved, which enriches the use experience of the automatic switch device 300. The display 13 may be configured as a touch display or a non-touch display, thus providing a visual screen for the keepers. The buttons 14 include switch buttons, parameter arrangement buttons, and the like. For example, when the keeper operates the switch button 14, the automatic switch device 300 automatically controls the opening or closing of the door plate 5, thus reducing the workload of the keeper in frequently manually opening and closing the door, while effectively avoiding management risks such as the animal not being able to obtain food, water, or escaping in time due to the human negligence of forgetting to open and close the door plate 5, and improving the efficiency and convenience of the management of the breeding animal. The prompt structure 15 may include, but is not limited to, a loudspeaker or a light structure, and the like, thus prompting the keeper to intervene in the automatic switch device 300 in a timely manner. The connection interface 16 may include, but is not limited to, a power supply interface, a communication interface, a function extension structure, and the like.

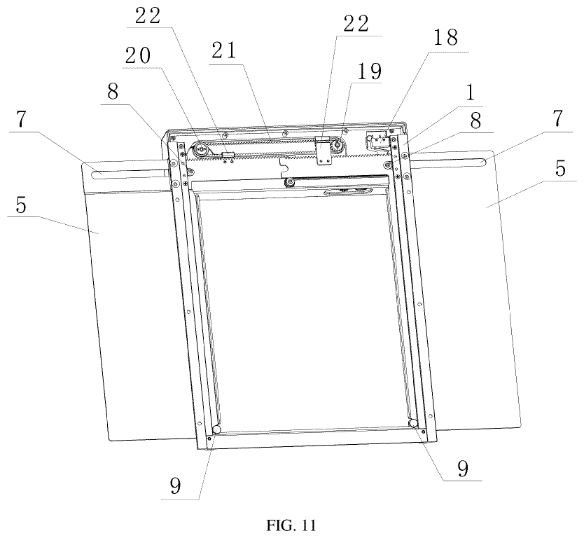

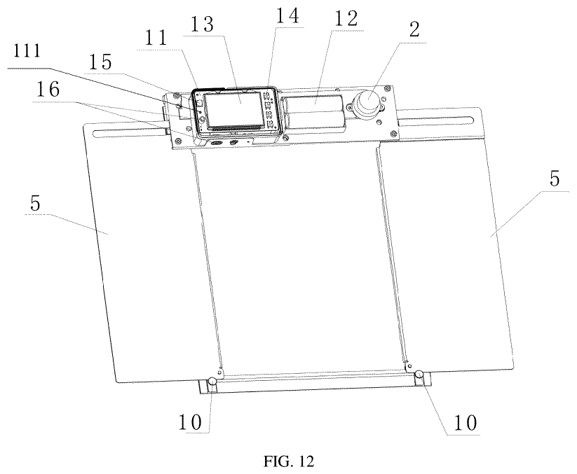

As illustrated in FIG. 1, FIG. 11 and FIG. 12, FIG. 11 is a partial schematic view of a back surface of the automatic switch device 300 according to a second embodiment of the present disclosure in an open state, and FIG. 12 is a partial schematic view of a front surface of the automatic switch device 300 shown in FIG. 11 in the open state. In the second embodiment, the structure of the automatic switch device 300 is similar to the structure of the automatic switch device 300 of the first embodiment, the difference is that: the transmission member 30 is configured as a belt transmission member. The belt transmission member includes a belt pulley 190, a belt 21, and a connection block 22. The belt pulley 190 is force-transmittingly coupled to the drive component 2. The belt 21 is rotatably arranged around an outer side of the belt pulley 190. An end of the connection block 22 is fixedly coupled to the belt 21, and an another end of the connection block 22 is fixedly coupled to the door plate 5. Since the belt 21 is elastic, the belt 21 can absorb vibrations and shocks and reduce vibrations and noise during the transmission process, which improves the stability and reliability of the translational movement of the door plate 5 relative to the door frame 1.

In the embodiment, the door plate 5 is provided as two in number. The two door plates 5 are coupled to the door frame 1. The two door plates 5 form a side-by-side door. The connection block 22 is provided as two in number. The two door plates 5 are fixedly coupled to the belt 21 by the two connection blocks 22, respectively. In a first aspect, the simultaneous opening of the two door plates 5 can provide a wider passageway opening 1001, which facilitates the rapid evacuation of chickens or personnel, and in a second aspect, the distance moved by each of the two door plates 5 relative to the door frame 1 is shortened, which improves the compactness of the overall structure of the automatic switch device 300.

Exemplarily, in the embodiment, each connection block 22 is integrally molded with an associated door plate 5, that is, each connection block 22 and the associated door plate 5 are made in one piece, thus enhancing the strength and stability of the connection between each door plate 5 and the associated connection block 22, reducing the risk of failure due to loose connection, and enhancing the overall performance and service life of the door plate 5. Of course, in some embodiments, each connection block 22 and the associated door plate 5 are independently provided of each other and fixedly connected, thus reducing the processing difficulty of the associated connection block 22 and each door plate 5, and facilitating maintenance.

The belt pulley 190 includes a drive pulley 19 and a driven pulley 20. The drive pulley 19 is force-transmittingly coupled to the drive component 2. The belt 21 is rotatably arranged around an outer side of the drive pulley 19 and an outer side of the driven pulley 20. Such that the drive component 2 is able to drive the drive pulley 19 to rotate, and the belt 21 and the driven pulley 20 is able to rotate by the rotation of the drive pulley 19. Of course, in some embodiments, the driven pulley 20 may be omitted. At least one of the drive pulley 19 and the driven pulley 20 is provided as one in number. In some embodiments, At least one of the drive pulley 19 and the driven pulley 20 is provided as a plurality in number, and the embodiments of the present disclosure are not specifically limited.

It is to be noted that the same structural elements in the automatic switch device 300 of the second embodiment as those in the automatic switch device 300 described in the first embodiment can be referred to the automatic switch device 300 described in the first embodiment, and will not be repeated herein. For example, the structure of the door plate 5 and the positional relationship between the door plate 5 and the door frame 1 described in the first embodiment are applicable to the second embodiment.

The above is only implementations of the present disclosure, not to limit the scope of the patent of the present disclosure. Any equivalent structure or equivalent process transformation utilizing the contents of the specification and the accompanying drawings of the present disclosure, or directly or indirectly applying in other related technical fields, are similarly included in the scope of patent protection of the present disclosure.

What is claimed is:

1. An automatic switch device, applied to a breeding house, wherein the automatic switch device comprises:
a door frame, configured to be mounted on an edge of a passageway opening of the breeding house;
at least one door plate, movably mounted on the door frame;
a transmission component, mounted on the door frame and being force-transmittingly coupled to the at least one door plate;
a drive component, mounted on the door frame and being force-transmittingly coupled to the transmission component, wherein the drive component is configured to drive the transmission component, and the transmission component is configured to drive the at least one door plate to move translationally relative to the door frame in a first direction to open or close the passageway opening;
an in-position detector or a cut-off switch, wherein the in-position detector is provided on the door frame and configured to generate a sensing signal when the in-position detector detects that the at least one door plate is moved to a closed position relative to the door frame; the cut-off switch is provided on the door frame and configured to cut off a power supply circuit connected with the drive component when the at least one door plate is moved to a closed position relative to the door frame; and
a main control board, wherein the main control board is connected with the in-position detector or the cut-off switch, the main control board is configured to receive the sensing signal detected by the in-position detector or receive a power cut-off signal sent by the cut-off switch, and configured to stop the drive component working according to the sensing signal or the power cut-off signal.

2. The automatic switch device of claim 1, wherein the door frame comprises a first cross beam and two vertical beams, the two vertical beams are coupled to two ends of the first cross beam, respectively, the in-position detector or the cut-off switch is provided at at least one end of the first cross beam in the first direction, and when the at least one door plate is moved to the closing position relative to the door frame, the at least one door plate moved to the closing position abuts against the in-position detector or the cut-off switch.

3. The automatic switch device of claim 1, wherein the at least one door plate is provided stacked with the door frame in a second direction, the second direction is parallel to an in-out direction of the passageway opening and perpendicular to the first direction, the automatic switch device further comprises a limit structure, the limit structure is provided on the door frame and/or the at least one door plate, and the limit structure is configured to limit a movement of the at least one door plate relative to the door frame in the second direction.

4. The automatic switch device of claim 3, wherein the limit structure comprises a first limit body and a second limit body, the first limit body is provided on the at least one door plate, the first limit body is configured to stop the door frame in the second direction, the second limit body is provided on the door frame, the second limit body is configured to stop the at least one door plate in the second direction, the at least one door plate is provided between the first limit body and the second limit body.

5. The automatic switch device of claim 1, wherein the transmission component comprises a driven gear and a rack, the driven gear is force-transmittingly coupled to the drive component, the rack is meshed with the driven gear, and the rack is fixedly coupled to the at least one door plate.

6. The automatic switch device of claim 5, wherein the door plate is provided as two in number, the two door plates are coupled to the door frame, the rack is provided as two in number, the driven gear comprises a main drive gear and a driven gear, the main drive gear is force-transmittingly coupled to the drive component, the driven gear is meshed with the main drive gear, one of the two door plates is meshed with the main drive gear by an associated rack, and an another door plate is engaged with the driven gear by an another associated rack; or, the driven gear comprises a main drive gear and two driven gears, the main drive gear is force-transmittingly coupled to the drive component, the two driven gears are both meshed with the main drive gear, and each of the two door plates is engaged with an associated driven gear by an associated rack; or, the driven gear comprises two main drive gears, the drive component is provided as two in number, the two main drive gears are force-transmittingly coupled to the two drive components, respectively, and each of the two door plates is engaged with an associated main drive gear by an associated rack.

7. The automatic switch device of claim 1, wherein the transmission component comprises a belt pulley, a belt, and a connection block, the belt pulley is force-transmittingly coupled to the drive component, the belt is rotatably arranged around an outer side of the belt pulley, an end of the connection block is fixedly coupled to the belt, and an another end of the connection block is fixedly coupled to the at least one door plate.

8. The automatic switch device of claim 7, wherein the door plate is provided as two in number, the two door plates are coupled to the door frame, the connection block is provided as two in number, each of the two door plates is fixedly coupled to the belt by an associated connection block.

9. The automatic switch device of claim 1, wherein the automatic switch device further comprises at least one slide structure, the at least one slide structure is provided on the door frame, the at least one door plate is provided with a slide groove arranged in one-to-one correspondence with each slide structure, an extension direction of each slide groove is parallel to the first direction, and each slide structure is slidably provided in an associated slide groove.

10. The automatic switch device of claim 9, wherein the door plate is provided as two in number, the two door plates are coupled to the door frame, the two door plates are staggered in second direction, the second direction is parallel to an in-out direction of the passageway opening, the drive component is configured to drive the transmission member to drive the two door plates to move translationally relative to the door frame in opposite directions.

11. The automatic switch device of claim 10, wherein the automatic switch device further comprises a first guide strip and a second guide strip, each of the first guide strip and the second guide strip is protruded on a side wall of the door frame facing toward the at least one door plate, and the first guide strip and the second guide strip are configured to abut against the two door plates, respectively.

12. The automatic switch device of claim 10, wherein the door frame is provided with a carrying structure, each door plate comprises a door plate body and an extension plate, in the same the door plate, the extension plate is coupled to a side portion of the door plate body in the first direction, and the extension plate of each door plate is provided between the transmission member and the carrying structure.

13. The automatic switch device of claim 12, wherein the carrying structure is provided extending along the second direction, a sidewall of the carrying structure is provided with a spacer strip, and the two door plates are located on both sides of the spacer strip in the second direction; or, a side wall of the carrying structure is provided with two limit grooves, the two limit grooves are provided spaced apart in the second direction, and the two door plates are provided in the two limit grooves, respectively.

14. The automatic switch device of claim 12, wherein each door plate further comprises a bending plate, in the same the door plate, the bending plate is coupled to a side of the door plate body near the extension plate in the first direction, and the two bending plates abut against each other when the passageway opening is closed by the two door plates.

15. The automatic switch device of claim 12, wherein in the same the door plate, the door plate body and the extension plate are coupled to form an avoidance notch, and when the passageway opening is closed by the two door plates, the avoidance notch provided on one of the two door plates is configured to arrange in avoidance with the door plate body of an another one of the two door plates therein.

16. The automatic switch device of claim 12, wherein in the same the door plate, a side of each extension plate facing away from the door plate body in the first direction is provided with a position notch, and when the passageway opening is closed by the two door plates, each slide structure is positioned in an associated position notch.

17. The automatic switch device of claim 12, wherein the carrying structure is rotatably provided relative to the door frame, or, the carrying structure is fixedly provided relative to the door frame.

18. The automatic switch device of claim 1, wherein the automatic switch device further comprises a protective housing, and the protective housing is mounted on the door frame and covered on an outside of the main control board, the drive component and the transmission component.

19. The automatic switch device of claim 18, wherein the automatic switch device further comprises an energy storage member, the energy storage member is electrically connected to the main control board and the drive component, and the protective housing is covered on an outside of the energy storage member.

20. The automatic switch device of claim 18, wherein the automatic switch device further comprises a function member, the function member is provided on the main control board, and the function member comprising at least one of a display, a button, a prompting structure and a connection interface.
